(19) United States
(12) Patent Application Publication
(10) Pub. No.: US 2013/0060693 A1
(43) Pub. Date: Mar. 7, 2013

(54) UNIFIED CHARGING SYSTEM

(71) Applicants: Ilya Oskolkov, Moscow (RU); Rodion Shishkov, St. Petersburg (RU)

(72) Inventors: Ilya Oskolkov, Moscow (RU); Rodion Shishkov, St. Petersburg (RU)

(73) Assignee: RAWLLIN INTERNATIONAL INC.

(21) Appl. No.: 13/226,163

(22) Filed: Sep. 6, 2011

(51) Int. Cl. G06Q 40/00

(52) U.S. Cl. 705/44; 705/39

(57) ABSTRACT

Technologies are generally described for systems and methods effective to create and use a unified charging system in a networking environment. In an example, a virtual charging card can be created and authenticated, and cash and credit accounts can be associated with the virtual charging card, and billing accounts can also be associated. In another example, a virtual charging card can be initialized when checking out at a shopping portal, and display a list of cash and credit accounts affiliated with the virtual charging card. One or more of the cash and credit accounts can be selected, and payment transferred to the shopping portal via the virtual charging card, masking the identity of the owner of the cash and credit accounts.

### TECHNICAL FIELD

This disclosure relates generally to a unified charging system in a networking environment.

### BACKGROUND

Online shopping has greatly increased in recent years, propelled by the ubiquitous use of mobile devices, and rapidly expanding Internet use. A plethora of services have arisen to simplify the shopping experience by offering services to consolidate the different type of payments that all the different online shopping sites require. Some of the services offer universal charge accounts that can be used across a wide range of websites. Others offer e-wallet systems to simplify the checkout procedures.

In reality, however, these services fail to simplify the entire process and personalize the payment and money transferring procedures. No single method exists to unify online payments and money transferring processes. Some of the services may serve assist with online shopping with mobile devices. Other services may assist with transferring money between accounts. Additional services may assist with bill payments. No single service however incorporates all of these tasks.

The above-described deficiencies of conventional payment and money transferring practices are merely intended to provide an overview of some of problems of current technology, and are not intended to be exhaustive. Other problems with the state of the art, and corresponding benefits of some of the various non-limiting embodiments described herein, may become further apparent upon review of the following detailed description.

### SUMMARY

In various non-limiting embodiments, systems and methods are provided to create and use a unified charging system in a networking environment. In an example embodiment, a method comprises creating a virtual charging card, adding cash and credit accounts to the virtual charging card, associating billing accounts with the virtual charging card, and authenticating the virtual charging card using authentication information.

In another example embodiment, a unified charging system comprises a registration component configured to receive registration information and create a virtual charging card, an association component configured to link cash accounts, credit accounts, and billing accounts to the virtual charging card, and an identification component configured to authorize the virtual charging card in response to receiving identification information.

In another example embodiment, a system comprises an activation component configured to initiate a virtual charging card in response to reception of an indication of a checkout at a shopping portal, a display component configured to display a list of cash and credit accounts affiliated with the virtual charging card, a selection component configured to select at least one of the cash and credit accounts affiliated with the virtual charging card. The system can further include a payment component configured to pay a balance at the shopping portal using at least one of the selectable cash and credit accounts, wherein the payment component obscures or hides an identity of the at least one cash and credit accounts.

In another example embodiment, a method comprises initializing a virtual charging card in response to receiving an indication of a checkout at a shopping portal, displaying a list of cash and credit accounts affiliated with the virtual charging card, selecting at least one of the cash and credit accounts affiliated with the virtual charging card, and transferring payment from the at least one cash and credit account selected to the shopping portal, wherein the transferring payment further comprises masking an identity of the at least one cash and credit account selected.

In another example embodiment, a computer readable storage medium comprising computer executable instructions that, in response to execution, cause a computing system to perform operations, comprising initializing a virtual charging card in response to receiving an indication of a checkout at a shopping portal, displaying a list of cash and credit accounts affiliated with the virtual charging card, selecting at least one of the cash and credit accounts affiliated with the virtual charging card, and transferring payment from the at least one cash and credit accounts selected to the shopping portal, wherein the transferring payment further comprises masking an identity of the at least one cash and credit accounts selected.

These and other embodiments are described in more detail below.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 is a block diagram illustrating an example, non-limiting embodiment of a unified charging system for creating a virtual charging card;

FIG. 2 illustrates a flow diagram of an example, non-limiting embodiment of a method for creating a virtual charging card;

FIG. 3 is a block diagram illustrating an example, non-limiting embodiment of a system for making payments using a virtual charging card;

FIG. 4 is a block diagram illustrating an example, non-limiting embodiment of a system for selecting non associated virtual charging cards to make payments to;

FIG. 5 illustrates a flow diagram of an example, non-limiting embodiment of a method for transferring money via a virtual charging card;

FIG. 6 is a block diagram illustrating an example, non-limiting embodiment of a system for shopping online with a virtual charging card;

FIG. 7 is a block diagram illustrating an example, non-limiting embodiment of a system for displaying the balance of cash and credit accounts affiliated with a virtual charging card;

FIG. 8 illustrates a flow diagram of an example, non-limiting embodiment of a method for shopping online and paying using a virtual charging card;

FIG. 9 illustrates a flow diagram of an example, non-limiting embodiment of a set of computer-readable instructions for shopping online and paying using a virtual charging card;

FIG. 10 is a block diagram illustrating an example networking environment that can be employed in accordance with the claimed subject matter;

FIG. 11 is a block diagram illustrating an example computing device that is arranged for at least some of the embodiments of the claimed subject matter; and

FIG. 12 illustrates an example of a mobile device that can process content in accordance with the claimed subject matter.

### DETAILED DESCRIPTION

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The words “exemplary” and/or “demonstrative” are used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

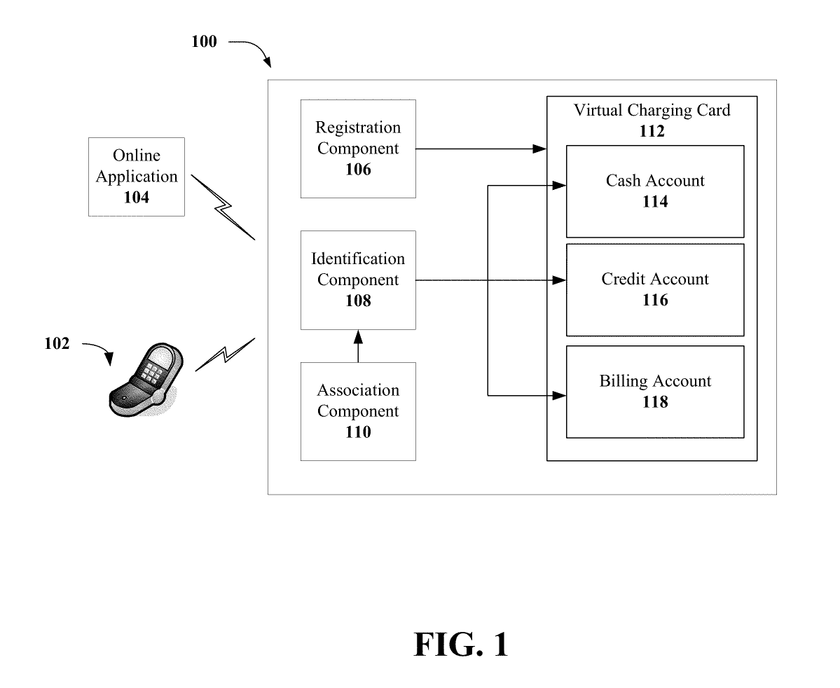

Turning now to FIG. 1, a block diagram illustrating an example, non-limiting embodiment of a unified charging system for creating a virtual charging card is shown. As shown in FIG. 1, a unified charging system 100 is provided to create and utilize a virtual charging card. The unified charging system can include a registration component 106, an identification component 108, an association component 110, and a virtual charging card 112. Virtual charging card 112 can be affiliated with cash accounts 114, and credit accounts 116 as well as billing accounts 118. For the sake of detail, while FIG. 1 is shown with a virtual charging card affiliated with cash, credit, and billing accounts, any combination of different types of accounts may be affiliated with virtual charging card 112.

To setup or create a virtual charging card, a mobile device 102 or a hosted online application 104 can be used to register an account. A client application can be installed on and operated by mobile device 102 to facilitate the registration, or a user can navigate to a website via a web browser with an online application form to register an account. Registration component 106 can receive the registration information from mobile device 102 over a wireless communications network, or can receive the registration information from hosted online application 104 over the Internet. The registration information can then be used to create virtual charging card 112.

Association component 110 can receive information from mobile device 102 or hosted online application 104 regarding bank accounts, debit accounts, and credit accounts that belong to, or are affiliated with the registrant. The information received by association component 110 can include, but is not limited to, bank account numbers, routing numbers, and credit card numbers. Association component 110 can also list third party billing accounts that are affiliated with the registrant. Such third party billing accounts may include, but are not limited to, utility bills, loan providers, internet service providers, charitable accounts, and etc. Association component 110 can associate these affiliated cash accounts 114, credit accounts 116, and billing accounts 118 with virtual charging card 112.

Identification component 108 can also receive identification information from mobile device 102 and hosted online application 104, which can include access and authorization information for linked accounts 114-118. The identification information can be used to ensure that the registrant has access and authorization to use linked accounts 114-118. Such identification information can include passwords, PIN numbers, social security numbers, driver's license numbers or any other form of identifying information to authorize access to the linked accounts. The identification information can also be used to grant the unified charging system access to the linked accounts.

Registration component 106 can also create for virtual charging card 112 a pseudo-identity during the registration process. The pseudo-identity is an identity that identifies virtual charging card 112, but does not identify the registrant. Unified charging system 100 can maintain a database (not pictured) that links pseudo-identities to the real identities of the registrants, but third parties that interact with virtual charging card 112 may not be able to identify the registrant.

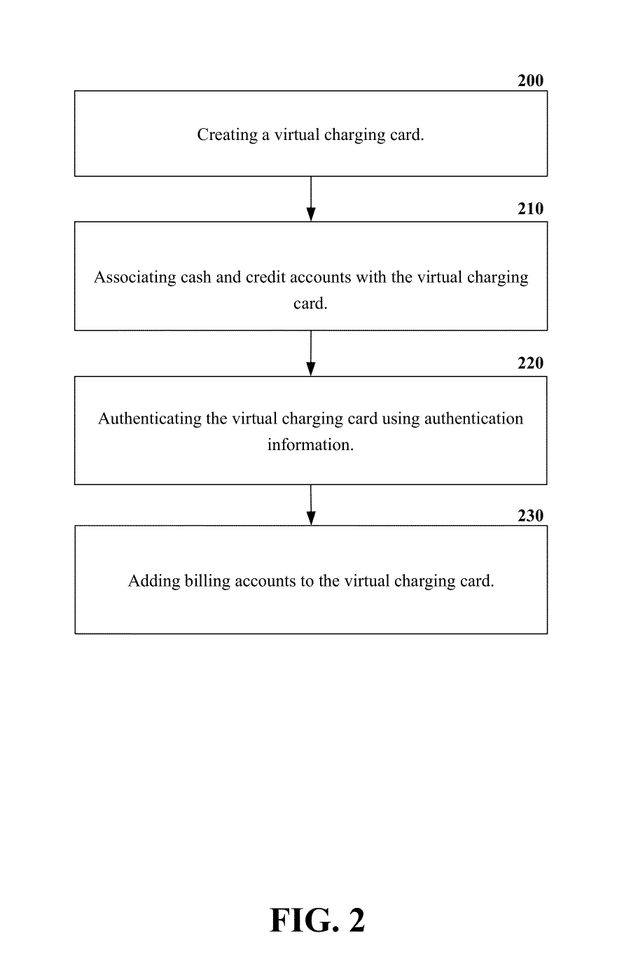

FIG. 2 illustrates a process in connection with the system of FIG. 1. The process in FIG. 2 can be implemented for example by system 100. FIG. 2 illustrates a flow diagram of an example, non-limiting embodiment of a method for creating a virtual charging card. At 200, a virtual charging card is created using registration information received from a client application installed on a mobile device, or from registration information received from a hosted online application accessed by a web browser. The information can be sent over the internet or a wireless communications network.

At 210, cash and credit accounts can be associated with the virtual charging card. The cash and credit accounts can be associated with the virtual charging card based on the received registration information. The information can include, but is not limited to, bank account numbers, routing numbers, and credit card numbers.

At 220, the virtual charging card can be authenticated using authentication information received from a client application installed on a mobile device, or from authentication information received from a hosted online application accessed by a web browser. The authentication information can identify the registrant, and include a social security number or a driver's license number. The authentication information can also include access information for the associated cash and credit accounts. The access information can be used to ensure that the virtual charging card has access to the cash and credit accounts, and can include passwords or PIN numbers for the bank accounts, credit card accounts, debit accounts or other sources of funds that may be associated with the virtual charging card.

At 230, billing accounts are added to the virtual charging card. The third party billing accounts may include, but are not limited to, utility bills, loan providers, internet service providers, charitable accounts, and etc. The billing accounts can be added in response to received registration information. The billing accounts can also be added automatically in response to a search done based on the identification information identifying the registrant.

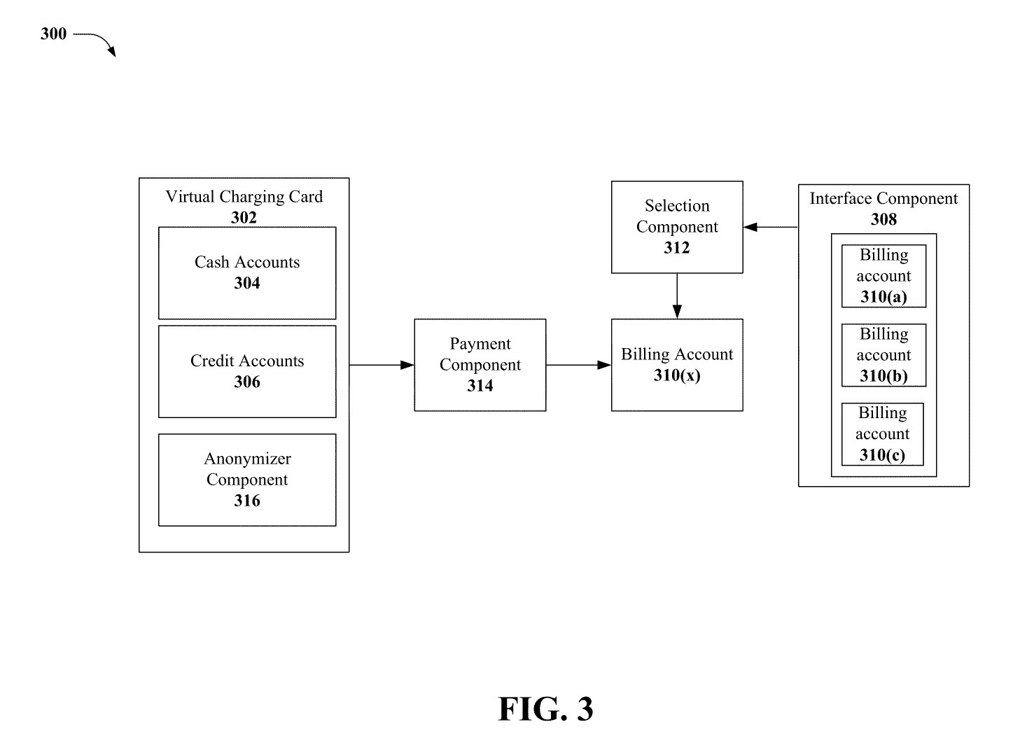

Turning now to FIG. 3, a block diagram illustrating an example, non-limiting embodiment of a system for making payments using a virtual charging card is shown. A system 300 is provided to make payments and transfer money using a unified charging system. The system 300 can include a virtual charging card 302 with associated cash accounts 304 and credit accounts 306, as well as anonymizer component 316. Interface component 308 can be provided to display and interact with a list of billing accounts 310(a)-(c). Selection component 312 can select at least one of the billing accounts and payment component 314 can be provided to transfer funds from one or more of the cash and credit accounts to the selected billing account 310(x).

Virtual charging card 302 can be linked to cash accounts 304 and credit accounts 306. Cash accounts 304 can include bank accounts and debit accounts, gift cards, or other sources of non-credit funds. Credit accounts 306 can include credit card accounts, store credit card accounts and other credit accounts a user of the virtual charging card may have. While virtual charging card 302 is depicted in FIG. 3 as having both cash accounts and credit accounts associated with it, any combination of accounts is possible, with only a single account linked, or multiple cash accounts with no credit accounts and vice versa.

Interface component 308 can display a list of associated billing accounts 310(a)-(c). The billing accounts can include, but are not limited to, utility bills, loan providers, internet service providers, charitable accounts, and etc. Any number and combination of billing accounts is possible, and interface component 308 can display each of the billing accounts. Interface component 308 can display billing accounts 310(a)-(c) via a web browser on the Internet or on a mobile device through a client application.

Selection component 312 can facilitate selection of at least one billing account 310(x) from billing accounts 310(a)-(c). The selection can be made by clicking on one of the billing accounts, or by selecting one of the accounts via a menu. Selection component 312 can also automatically select one of the billing accounts based on a variety of means. If there are multiple loan accounts, with different balances and interest rates, selection component 312 can automatically select the loan account with the higher interest rate, or larger balance. Selection component 312 can also select multiple accounts, and assign priority rankings to each of the accounts, wherein billing accounts with higher priority rankings are selected to be paid first by payment component 314.

When at least one billing account has been selected by selection component 312, payment component 314 can transfer funds from at least one of the cash accounts 304 and credit accounts 306 to billing account 310(x). Cash accounts 304 and Credit accounts 306 can be selected from a client application on a mobile device or via a hosted online application. Selection can be done manually or automatically. If selection of which cash or credit account to use for payment is done automatically, the selection can be made in response to a set of defined rules. The account with the highest balance can be automatically selected, or certain cash accounts and credit accounts can be given a higher ranking and may be selected first.

Payment component 314 can also schedule automatic payments. If selected billing account 310(x) is a utility billing account, or is a charitable donation billing account, or any other type of billing account where regular periodic payments are relevant, payment component 314 can schedule such automatic payments. Payment component 314 can also transfer funds between the affiliated cash accounts 304 and credit accounts 306. Virtual charging card 302 can include multiple cash accounts and credit accounts, and payment component 314 can transfer money between any one of the cash accounts and credit accounts to any other cash and credit accounts.

Anonymizer component 316 can mask an identity of the holder of virtual charging card 302. When payments made by payment component 314 to billing account 310(x) occur, anonymizer component 316 can generate temporary account information for virtual charging card 302 such that billing account 310(x) can only learn the temporary account information, and not the true identity of virtual charging card 302.

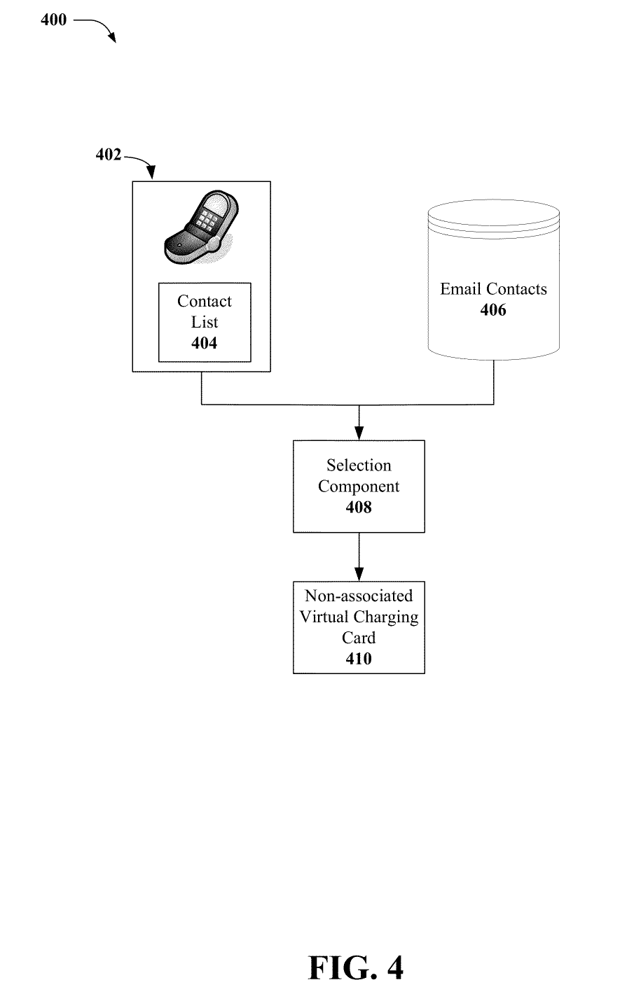

In another embodiment, payment component 314 can also transfer funds from at least one of affiliated cash accounts 304 or credit accounts 306 to another virtual charging card (shown in FIG. 4). In this embodiment, selection component 312 can select a virtual charging card that is not associated with virtual charging card 302. A virtual charging card that is not associated with virtual charging card 302 can be a virtual charging card that belongs to another user. In this embodiment, funds can be transferred from person to person without directly transferring money from bank account to bank account, simplifying and personalizing the transferring process. This selection process is described in more detail in FIG. 4.

Turning now to FIG. 4, a block diagram illustrating an example, non-limiting embodiment of a system for selecting non associated virtual charging cards to make payments to is shown. The system 400 for selecting a non-associated virtual charging card to make payments to can include a selection component 408 which can assist selection of a non-associated virtual charging card 410 from a list of non-associated virtual charging cards affiliated with a set of email contacts 406 or mobile phone contacts 404 stored on mobile device 402. The email contacts 406 can be stored in an address book on a local computer, or can be stored online, in a web based email server. The contact list 404 stored on mobile device 402 can be accessed by a client application installed on mobile device 402.

Selection component 408 can determine if there are virtual charging accounts affiliated with the email contacts or mobile phone contacts, and those virtual charging accounts can be selected by selection component 408 for payment to be transferred to them from payment component 314.

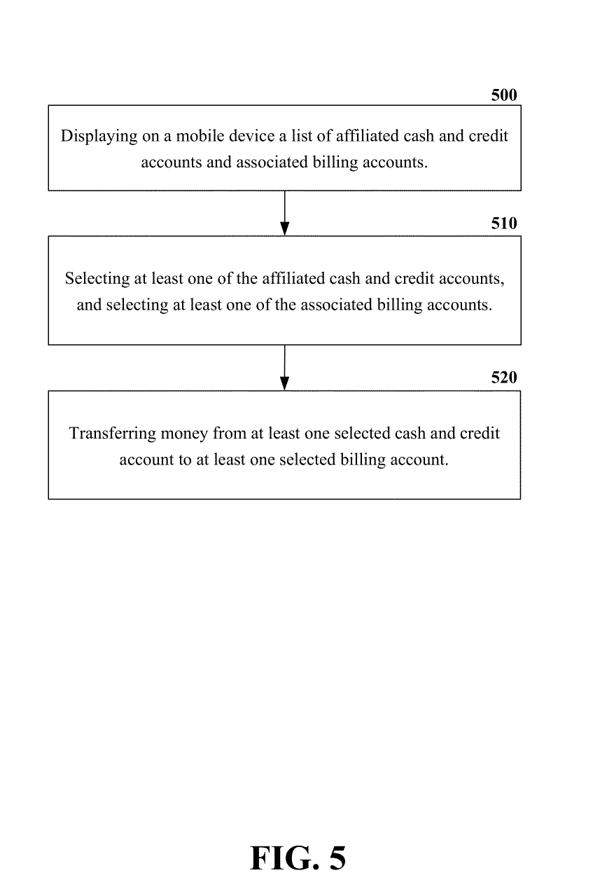

FIG. 5 illustrates a process in connection with systems 300 and 400 of FIG. 3 and FIG. 4 respectively. The process of FIG. 5 can be implemented for example by systems 300 and 400.

FIG. 5 illustrates a flow diagram of an example, non-limiting embodiment of a method for transferring money via a virtual charging card. At 500, a list of affiliated cash and credit accounts and associated billing accounts can be displayed on a mobile device. The balances of each of the affiliated cash and credit accounts can also be displayed, providing information about the balance of funds left in each account. Similarly, balances of the associated billing accounts can also be shown, displaying the amount of money owed to each of the billing accounts.

In an alternative embodiment, a list of non-associated virtual charging cards can be displayed in addition to or in place of the associated billing accounts. The non-associated virtual charging cards can be affiliated with mobile device contacts or email addresses stored in a mobile device, computer, or web-based email server.

At 510, at least one of the affiliated cash and credit accounts can be selected. At least one of the associated billing accounts can also be selected. In an alternative embodiment, at least one of the non-associated virtual charging cards can also be selected.

At 520, money can be transferred from the selected cash and credit accounts to the selected billing accounts. Money can also be transferred to the selected non-associated virtual charging cards. These payments can be automated according to a payment schedule. In an alternative embodiment, these payments can also be automated in response to a trigger event. In this embodiment, payments can automatically be made whenever a balance on a billing account reaches a certain level. Similarly, a payment can automatically be made whenever a balance on a non-associated virtual charging card falls below a certain level.

In another embodiment, when payments are made from the affiliated cash and credit accounts to a billing account or another virtual charging card, the payment can be anonymized so that the payee cannot learn the identity of the payer. A temporary charging account identity, or a pseudo-identity, can take the place of the payer's identity to anonymize the payment.

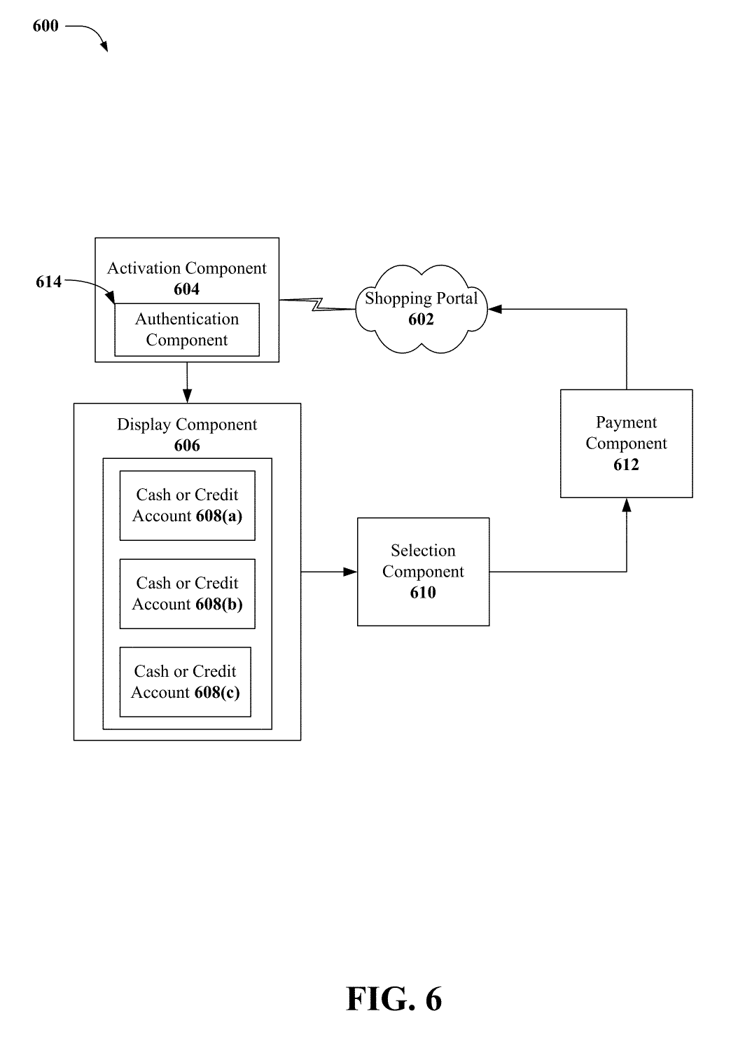

Turning now to FIG. 6 a block diagram illustrating an example, non-limiting embodiment of a system for shopping online with a virtual charging card is shown. System 600 is provided to enable payments using a virtual charging card at a shopping portal. Activation component 604 can be provided to receive an indication of activity at a shopping portal 602. Display component 606 can be provided to display cash or credit accounts 608(a)-(c). Selection component 610 can be provided to select one of the cash or credit accounts 608(a)-(c) and payment component 612 can be provided to effectuate payment from the selected cash or credit account to shopping portal 602.

Activation component 604 can receive an indication that a checkout procedure has been initiated at shopping portal 602. Shopping portal 602 can be accessed via a web browser on a mobile device, through a client application on a mobile device, or via a web browser on a non-mobile device computer. After selecting items or services to purchase at the shopping portal, and proceeding to the checkout screen, an indication can be sent to activation component 604 to initiate a virtual charging card. Alternatively, the indication can be sent when the virtual charging card is selected as a payment option shopping portal 602.

When the indication is received by activation component 604, authentication component 614 can authenticate the virtual charging card. To authenticate the virtual charging card, identification information such as stored credentials or a manually entered password/PIN number can be used to verify the identity of the user of the virtual charging card.

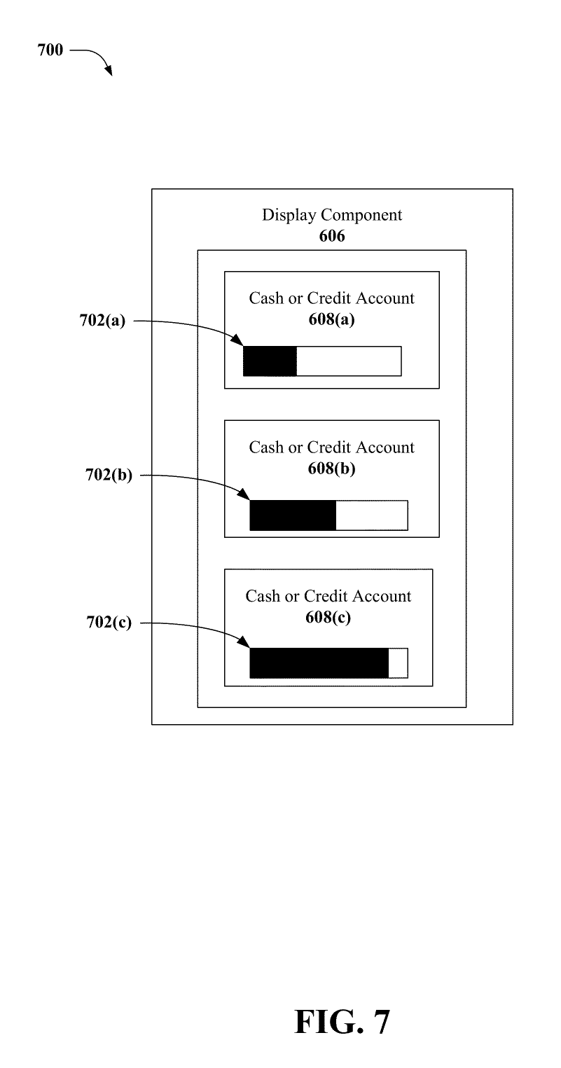

Display component 606 can display a list of affiliated cash and credit accounts 608(a)-(c) after activation component 604 has initiated the virtual charging card. The list of cash and credit accounts 608(a)-(c) can be those that have previously been associated with the virtual charging card. Display component 606 can also display balances of each of the cash or credit accounts (shown in FIG. 7). Display component 606 can display the cash or credit accounts on the same page as the checkout screen, or display component 606 can display the list of accounts in a pop-up window.

In one embodiment, if the shopping portal is accessed via a web browser on a non-mobile device, the display component can display the list of accounts in the same web browser, or in a pop-up window on the same device. Similarly, if the shopping portal is accessed via a mobile device web browser or client application, display component 606 can display the accounts associate with the virtual charging card on the mobile device. In an alternative embodiment, if the shopping portal is accessed via a non-mobile device, display component 606 can display the list of accounts on a mobile device and vice versa.

Selection component 610 can be used to select at least one of cash and credit accounts 608(a)-(c) to use for payment at the shopping portal. Selection component 610 can select one of the cash or credit accounts displayed on the mobile device or non-mobile device at the shopping portal page, or can select one of the cash or credit accounts displayed in the pop-up window.

In one embodiment, selection component 610 can automatically select a cash or credit account for payment based on the balance of the cash or credit accounts. Selection component 610 can select the cash or credit account with the highest balance, or can select from a set of cash or credit accounts with a balance above a defined threshold.

In another embodiment, selection component can select a cash or credit account according to other criteria. If a shopping portal offers a discount for certain types of payment accounts, such as offering a discount for a bank account transfers, or credit cards accounts, selection component 610 can automatically select the cash or credit account that offers the best discount. In an alternative embodiment, some shopping portals may not accept certain types of credit cards, and may only accept credit card accounts affiliated with certain providers such as MasterCard or VISA. In this embodiment, selection component 610 can take those criteria into account when selecting a credit account.

In another embodiment, the virtual charging card may not be integrated with the shopping portal. In this embodiment, a pop-up window can be started to override the regular checkout options at the shopping portal. Selection component 610 can facilitate manual entry of an account number associated with a cash or credit account. This number can be entered into the pop-up window manually.

Once a selection of at least one of the cash or credit accounts 608(a)-(c) has been made, payment component 612 can be used to transfer funds to shopping portal 602. Payment component 612 can mask the identity of the cash or credit account used to pay the balance at the shopping portal by creating a temporary charging account identity. The temporary charging account identity can be used in lieu of a real identity so that the payment is made, and cannot be traced back to the cash or credit account selected.

In another embodiment, payment component 612 can complete the transfer of funds to shopping portal 602 even if cash or credit accounts 608(a)-(c) do not have a sufficient balance to pay the balance at shopping portal 602.

Turning now to FIG. 7, a block diagram illustrating an example, non-limiting embodiment of a system 700 for displaying the balance of cash and credit accounts affiliated with a virtual charging card is shown. Display component 606 can display cash or credit accounts 608(a)-(c) on a mobile device or on a non-mobile device. The display may be made in a pop-up window or on the same page as the checkout page at the shopping portal. Balances 702(a)-(c) can be shown alongside cash or credit accounts 608(a)-(c). Balances 702(a)-(c) can show the balance remaining for each of the cash or credit accounts. For instance, if account 608(a) is a bank account, the balance 702(a) can show the amount of funds in the bank account. If account 608(b) is a credit account, balance 702(b) can show the credit level and balance of account 608(b).

Display component 606 can access the accounts using authorization information that was received when the virtual charging card was created, in order to determine the balance of each of the cash or credit accounts.

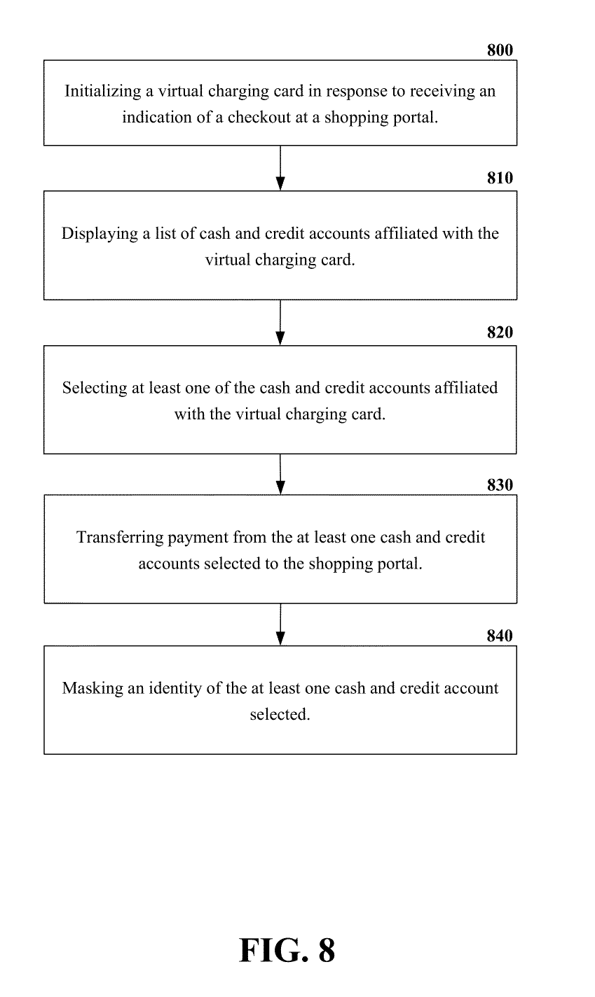

FIG. 8 illustrates a process in connection with systems 600 and 700 of FIG. 6 and FIG. 7 respectively. The process of FIG. 8 can be implemented for example by systems 600 and 700. FIG. 8 illustrates a flow diagram of an example, non-limiting embodiment of a method for shopping online and paying using a virtual charging card.

At 800, a virtual charging card is initialized in response to receiving an indication of a checkout at a shopping portal. The indication of a checkout can be received when the checkout screen at a shopping portal is accessed or can be sent when the virtual charging card payment option is selected at the shopping portal. The initializing the virtual charging card can include authentication procedures. To enable the virtual charging card, login information may be required. The login information can be manually entered, or security credentials stored on a mobile device can be accessed to authenticate the virtual charging card.

At 810, a list of cash and credit accounts affiliated with the virtual charging card can be displayed. A balance of each of the cash and credit accounts displayed can also be provided. The list of cash and credit accounts can be displayed on the checkout page of the shopping portal, or can be displayed in a pop-up window.

At 820, at least one of the cash and credit accounts affiliated with the virtual charging card can be selected. The selection can be made manually or automatically. If made automatically, the selection can be based on criteria such as a balance threshold, or whether a shopping portal offers discounts if using certain types of cash or credit accounts. For instance, if a shopping portal offers a discount if using a bank transfer, the cash account can be selected. The selecting of the cash or credit account can also be made automatically based on the cash or credit account with the highest remaining balance. Selecting the cash or credit account can also be made by manually entering an account number of the cash or credit account into the shopping portal.

At 830, payment can be transferred from the selected cash or credit account to the shopping portal. At 840, the identity of the cash and credit account selected for payment, can be masked. During the paying process, a temporary charging account identity can be created. This temporary identity can be used instead of the real identity of the cash or credit account selected in order to mask the identity of the cash or credit account.

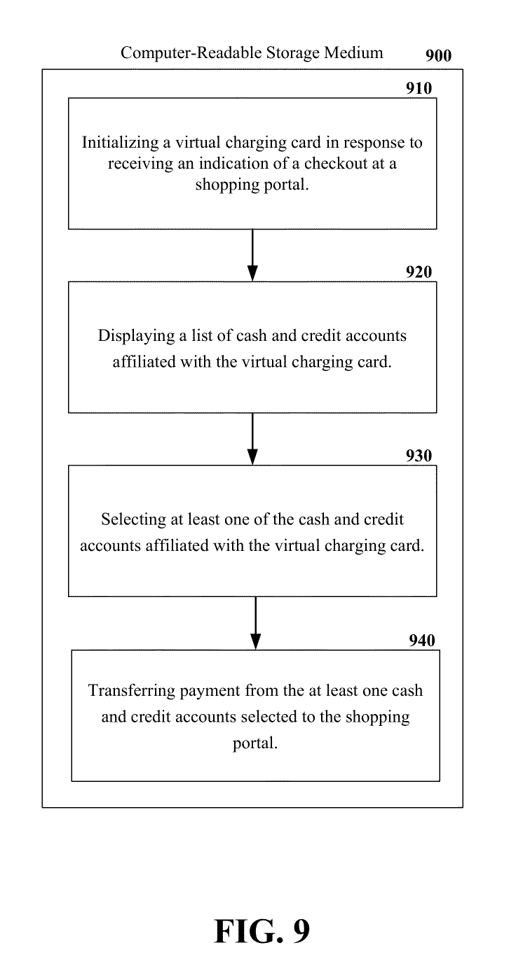

FIG. 9 illustrates a flow diagram of an example, non-limiting embodiment of a set of computer-readable instructions for shopping online and paying using a virtual charging card. Compute readable storage medium 900 can include computer executable instructions. At 910, these instructions can operate to initialize a virtual charging card in response to receiving an indication of a checkout at a shopping portal. The instructions can also operate to initialize the virtual charging card upon selection of a virtual charging card payment option at the checkout page of the shopping portal.

At 920, these instructions can operate to display a list of cash and credit accounts affiliated with the virtual charging card. The balance of each of the cash and credit accounts can also be displayed. The list of cash and credit accounts can be displayed on the checkout page of the shopping portal, or can be displayed in a pop-up window

At 930, these instructions operate to select at least one of the cash and credit accounts affiliated with the virtual charging card. The instructions can also operate to select at least one of the cash and credit accounts automatically. The selection can be based on criteria such as a balance threshold, or whether a shopping portal offers discounts if using certain types of cash or credit accounts. For instance, if a shopping portal offers a discount if using a bank transfer, the cash account can be selected. The selecting of the cash or credit account can also be made automatically based on the cash or credit account with the highest remaining balance.

At 940, these instructions can operate to transfer payment from the selected cash or credit account to the shopping portal. The identity of the cash and credit account selected for payment, can be masked. During the paying process, a temporary charging account identity can be created. This temporary identity can be used instead of the real identity of the cash or credit account selected in order to mask the identity of the cash or credit.

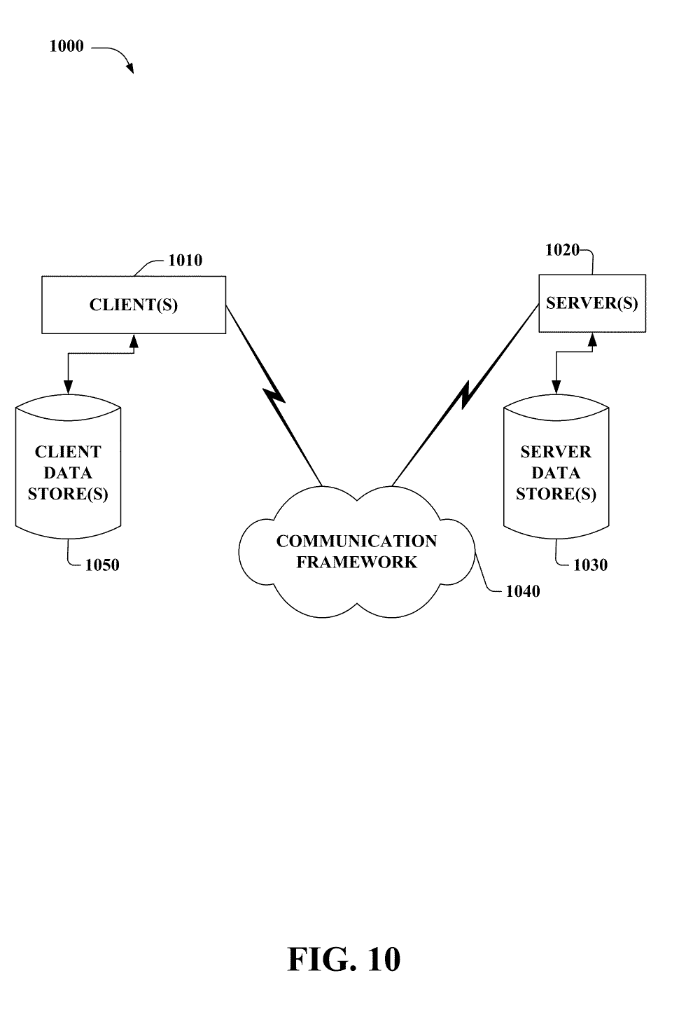

Turning now to FIG. 10 a block diagram illustrating an example networking environment that can be employed in accordance with the claimed subject matter is shown. The system 1000 includes one or more client(s) 1010. The client(s) 1010 can be hardware and/or software (e.g., threads, processes, computing devices). The system 1000 also includes one or more server(s) 1020. The server(s) 1020 can be hardware and/or software (e.g., threads, processes, computing devices). The servers 1020 can house threads to perform transformations by employing the subject innovation, for example.

One possible communication between a client 1010 and a server 1020 can be in the form of a data packet adapted to be transmitted between two or more computer processes. The system 1000 includes a communication framework 1040 that can be employed to facilitate communications between the client(s) 1010 and the server(s) 1020. The client(s) 1010 are operably connected to one or more client data store(s) 1050 that can be employed to store information local to the client(s) 1010. Similarly, the server(s) 1020 are operably connected to one or more server data store(s) 1030 that can be employed to store information local to the servers 1020.

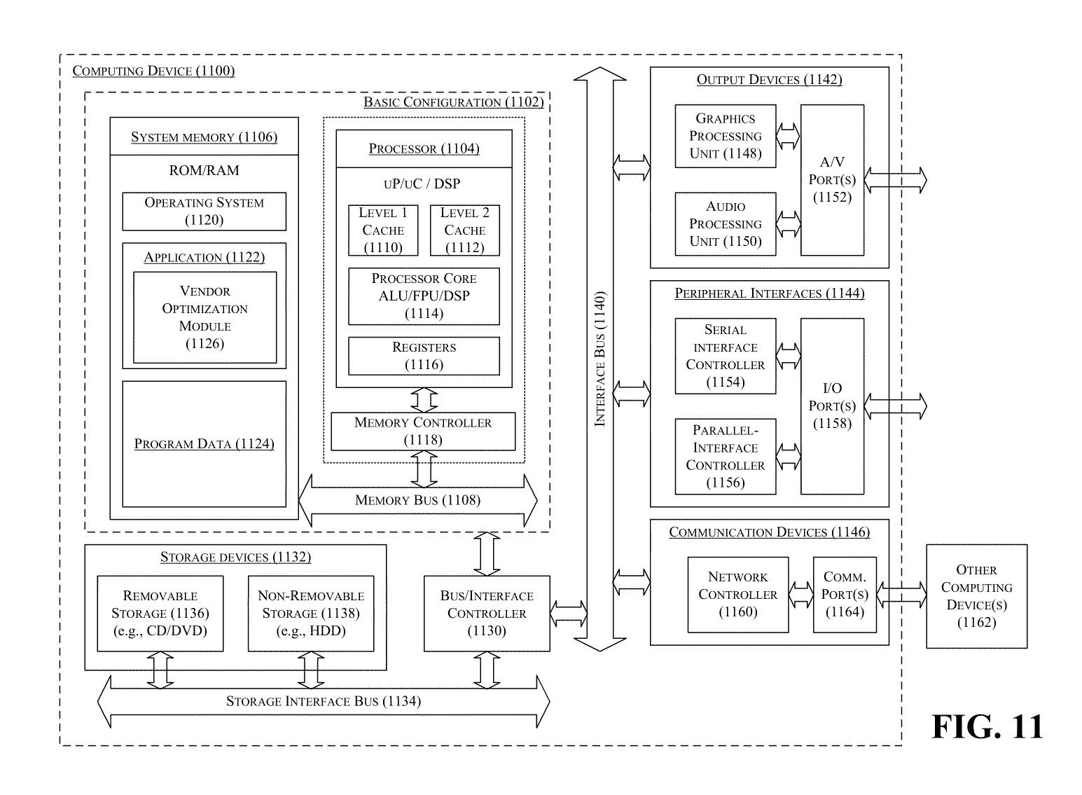

Referring now to FIG. 11, there is illustrated a block diagram of a computer operable to provide networking and communication capabilities between a wired or wireless communication network and a server and/or communication device. In order to provide additional context for various aspects thereof, FIG. 11 and the following discussion are intended to provide a brief, general description of a suitable computing environment 1300 in which the various aspects of the innovation can be implemented. While the description above is in the general context of computer-executable instructions that can run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the exemplary environment 1100 for implementing various aspects includes a computer 1102, the computer 1302 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 can also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1111 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the disclosed innovation.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is to be appreciated that the innovation can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 2394 serial port, a game port, a USB port, an IR interface, etc.

A monitor 1144 or other type of display device is also connected to the system bus 1108 through an interface, such as a video adapter 1146. In addition to the monitor 1144, a computer typically includes other peripheral output devices (not shown), such as speakers, printers, etc.

The computer 1102 can operate in a networked environment using logical connections by wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 through the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least wireless fidelity (WiFi) and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE 802.11(a, b, g, etc.) to provide secure, reliable, fast wireless connectivity. A WiFi network can be used to connect computers to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

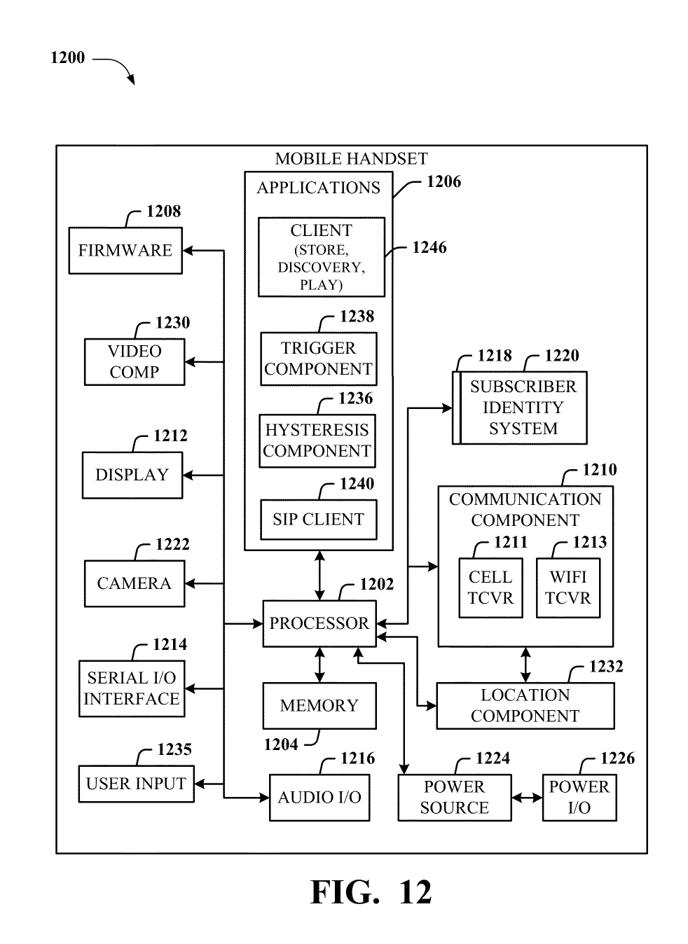

FIG. 12 illustrates a schematic block diagram of an exemplary device 1200 capable of employing the subject system in accordance with some embodiments of the invention. The device is a mobile handset 1200 In order to provide additional context for various aspects thereof, FIG. 12 and the following discussion are intended to provide a brief, general description of a suitable environment 1200 in which the various aspects can be implemented. While the description includes a general context of computer-executable instructions, those skilled in the art will recognize that the innovation also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the inventive methods can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of computer-readable media. Computer readable media can be any available media that can be accessed by the computer and includes both volatile and non-volatile media, removable and non-removable media. By way of example and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 1200 includes a processor 1202 for controlling and processing all onboard operations and functions. A memory 1204 interfaces to the processor 1202 for storage of data and one or more applications 1206 (e.g., a video player software, user feedback component software, . . . ). Other applications can include voice recognition of predetermined voice commands that facilitate initiation of the user feedback signals. The applications 1206 can be stored in the memory 1204 and/or in a firmware 1208, and executed by the processor 1202 from either or both the memory 1204 or/and the firmware 1208. The firmware 1208 can also store startup code for execution in initializing the handset 1200. A communications component 1210 interfaces to the processor 1202 to facilitate wired/wireless communication with external systems, e.g., cellular networks, VoIP networks, and so on. Here, the communications component 1210 can also include a suitable cellular transceiver 1211 (e.g., a GSM transceiver) and an unlicensed transceiver 1213 (e.g., WiFi, WiMax) for corresponding signal communications. The handset 1200 can be a device such as a cellular telephone, a PDA with mobile communications capabilities, and messaging-centric devices. The communications component 1210 also facilitates communications reception from terrestrial radio networks (e.g., broadcast), digital satellite radio networks, and Internet-based radio services networks.

The handset 1200 includes a display 1212 for displaying text, images, video, telephony functions (e.g., a Caller ID function), setup functions, and for user input. The display 1212 can also accommodate the presentation of multimedia content (e.g., music metadata, messages, wallpaper, graphics, . . . ). A serial I/O interface 1214 is provided in communication with the processor 1202 to facilitate wired and/or wireless serial communications (e.g., USB, and/or IEEE 1394) through a hardwire connection, and other serial input devices (e.g., a keyboard, keypad, and mouse). This supports updating and troubleshooting the handset 1200, for example. Audio capabilities are provided with an audio I/O component 1216, which can include a speaker for the output of audio signals related to, for example, indication that the user pressed the proper key or key combination to initiate the user feedback signal. The audio I/O component 1216 also facilitates the input of audio signals through a microphone to record data and/or telephony voice data, and for inputting voice signals for telephone conversations.

The handset 1200 can include a slot interface 1218 for accommodating a SIC (Subscriber Identity Component) in the form factor of a card Subscriber Identity Module (SIM) or universal SIM 1220, and interfacing the SIM card 1220 with the processor 1202. However, it is to be appreciated that the SIM card 1220 can be manufactured into the handset 1200, and updated by downloading data and software thereto.

The handset 1200 can process IP data traffic through the communication component 1210 to accommodate IP traffic from an IP network such as, for example, the Internet, a corporate intranet, a home network, a person area network, etc., through an ISP or broadband cable provider. Thus, VoIP traffic can be utilized by the handset 1200 and IP-based multimedia content can be received in either an encoded or decoded format.

A video processing component 1222 (e.g., a camera) can be provided for decoding encoded multimedia content. The handset 1200 also includes a power source 1224 in the form of batteries and/or an AC power subsystem, which power source 1224 can interface to an external power system or charging equipment (not shown) by a power I/O component 1226.

The handset 1200 can also include a video component 1230 for processing video content received and, for recording and transmitting video content. A location tracking component 1232 facilitates geographically locating the handset 1200. As described hereinabove, this can occur when the user initiates the feedback signal automatically or manually. A user input component 1234 facilitates the user initiating the quality feedback signal. The input component can include such conventional input device technologies such as a keypad, keyboard, mouse, stylus pen, and touch screen, for example.

Referring again to the applications 1206, a hysteresis component 1236 facilitates the analysis and processing of hysteresis data, which is utilized to determine when to associate with the access point. A software trigger component 1238 can be provided that facilitates triggering of the hysteresis component 1238 when the WiFi transceiver 1213 detects the beacon of the access point. A SIP client 1240 enables the handset 1200 to support SIP protocols and register the subscriber with the SIP registrar server. The applications 1206 can also include a client 1242 that provides at least the capability of discovery, play and store of multimedia content, for example, music.

The handset 1200, as indicated above related to the communications component 1210, includes an indoor network radio transceiver 1213 (e.g., WiFi transceiver). This function supports the indoor radio link, such as IEEE 802.11, for the dual-mode GSM handset 1200. The handset 1200 can accommodate at least satellite radio services through a handset that can combine wireless voice and digital radio chipsets into a single handheld device.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A method, comprising:
creating, by a system comprising a processor, a virtual charging card;
adding, by the system, a cash or credit account to the virtual charging card;
associating, by the system, a billing account with the virtual charging card;
authenticating, by the system, the virtual charging card using authentication information; and
transferring, by the system, a payment from the cash or credit account to the billing account via the virtual charging card, wherein information representing an identity of an account holder associated with the cash or credit account is masked from the billing account.

2. The method of claim 1, further comprising registering, by the system, the virtual charging card over a wireless communications network with a client application installed on a mobile device.

3. The method of claim 1, further comprising, accessing, by the system, a hosted online application and registering the virtual charging card over a wide area network via the hosted online application.

4. The method of claim 2, wherein the authenticating the virtual charging card further comprises:
receiving, by the system, the authentication information via the client application on the mobile device; and
transmitting, by the system, the authentication information via the mobile device over the wireless communication network.

5. The method of claim 3, further comprising receiving, by the system, the authentication information from the hosted online application.

6. The method of claim 2, further comprising establishing, by the system, a pseudo-identity associated with the virtual charging card.

7. The method of claim 3, further comprising establishing, by the system a pseudo-identity associated with the virtual charging card.

8. The method of claim 1, further comprising authenticating, by the system, the virtual charging card with identifying information.

9. A system, comprising:
a memory storing computer-executable instructions; and
a processor, communicatively coupled to the memory, which facilitates execution of the computer-executable instructions to at least:
receive registration information and create a virtual charging card;
link a cash or credit account, and a billing account to the virtual charging card;
authorize the virtual charging card in response to receiving identification information; and
transfer funds from at least one of the cash or credit account to the billing account, wherein information representing an identity associated with an account holder associated with the virtual charging card is hidden from the billing account.

10. The system of claim 9, wherein the processor further facilitates the execution of the computer executable instructions to:
receive the registration information from a client application installed on a mobile device.

11. The system of claim 9, wherein the processor further facilitates the execution of the computer executable instructions to:
receive the registration information from a hosted online application accessed by a web browser.

12. The system of claim 9, wherein the processor further facilitates the execution of the computer executable instructions to:
link the cash or credit account and the billing account to the virtual charging card based on the registration information.

13. The system of claim 12, wherein the identification information is received from a client application on a mobile device.

14. The system of claim 12, wherein the identification information is received from a hosted online application accessed by a web browser.

15-30. (canceled)

31. The method of claim 1, further comprising generating, by the system, a temporary charging account identity for the transferring the payment

32. The method of claim 1, further comprising guaranteeing, by the system, the transferring the payment in response to determining a fund level of cash or credit account is below a balance at the shopping portal.

33. The method of claim 1, further comprising displaying, by the system, a list of cash and credit accounts affiliated with the virtual charging card.

34. The method of claim 33, further comprising receiving, by the system, a selection of at least one of the cash and credit accounts from the list of cash and credit accounts for the transferring the payment.

35. The system of claim 9, wherein the processor further facilitates the execution of the computer executable instructions to create a temporary charging account identity to transfer the funds to the billing account.

36. The system of claim 9, wherein the processor further facilitates the execution of the computer executable instructions to transfer funds to the billing account from a second credit account that is not associated with the virtual charging card in response to the cash or credit account having insufficient funds.

37. The system of claim 9, wherein the processor further facilitates the execution of the computer executable instructions to display a list of cash and credit accounts affiliated with the virtual charging card.

38. A non transitory computer-readable storage device comprising computer-executable instructions that, in response to execution, cause a computing system to perform operations, comprising:
creating a virtual charging card;
associating a cash or credit account and a billing account with the virtual charging card;
authenticating the virtual charging card using identification information; and
transferring a payment from the cash or credit account to the billing account, wherein information representing an identity associated with a account holder of the cash or credit account is hidden from the billing account.

39. The non-transitory computer-readable storage device of claim 38, wherein the operations further comprise displaying a list of cash and credit accounts affiliated with the virtual charging card.

40. The non-transitory computer-readable storage device of claim 39, wherein the operations further comprise receiving a selection of at least one of the cash and credit accounts from the list of cash and credit accounts for the transferring the payment.
